(19) United States
(12) Patent Application Publication
(10) Pub. No.: US 2010/0200168 A1
(43) Pub. Date: Aug. 12, 2010

(54) FIBER DELIVERY APPARATUS AND SYSTEM HAVING A CREEL AND FIBER PLACEMENT HEAD SANS FIBER REDIRECT

(75) Inventors: Tino Oldani, Rockford, IL (US); Klaus Hoffmann, Rockford, IL (US); William R. Dent, Rockford, IL (US)

Correspondence Address: REINHART BOERNER VAN DEUREN P.C., 2215 PERRYGREEN WAY, ROCKFORD, IL, 61107, US

(73) Assignee: INGERSOLL MACHINE TOOLS, INC., Rockford, IL (US)

(21) Appl. No.: 12/696,476

(22) Filed: Jan. 29, 2010

Related U.S. Application Data
(60) Provisional application No. 61/150,658, filed on Feb. 6, 2009.
(60) Provisional application No. 61/231,571, filed on Aug. 5, 2009.

(51) Int. Cl. B29C 70/28

(52) U.S. Cl. 156/441

(57) ABSTRACT

A fiber delivery apparatus having a creel assembly and a fiber placement head is provided. A plurality of fiber spools are stored in the creel assembly. The tow paths from the spools to the fiber placement head are substantially fixed such that movements orienting the fiber placement head relative to a tool are simultaneously applied to the fiber spools as well. As such, the length and orientation of the tow paths between the spools and the fiber placement head are constant.

### CROSS-REFERENCE TO RELATED PATENT APPLICATIONS

This patent application claims the benefit of U.S. Provisional Patent Application No. 61/150,658, filed Feb. 6, 2009, the entire teachings and disclosure of which are incorporated herein by reference thereto. This patent application claims the benefit of U.S. Provisional Patent Application No. 61/231,571, filed Aug. 5, 2009, the entire teachings and disclosure of which are incorporated herein by reference thereto.

### FIELD OF THE INVENTION

This invention generally relates to automated composite fiber placement manufacturing apparatuses and methods.

### BACKGROUND OF THE INVENTION

In the practice of composite fiber manufacturing, the common method has been the utilization of a plurality of thin, narrow strips of material, embedded with a variety of chemical elements, applied in repetitive applications or “lay-ups” onto a fixed or moving surface. The strips of chemically embedded material are commonly referred to as “tows” and a collection of tows in a wider, multiple tow presentation may be referred to as “tape.” In either case, tow or tape applications in multiple layers and repeated lay-ups are cause for the build-up of material that, when processed through an autoclave under closely monitored and controlled atmospheric conditions, yield a solid “composite” material of substantial strength, yet light in weight.

Accordingly, composite fiber placement manufacturing relies upon a fiber placement delivery system, generally achieved through the combination of a positioning device, or “positioner,” and a composite fiber tape or tow application device, which may generally be described as a “fiber application device.” The portion that directly controls the placement of the fiber tape or tow may also be referred to as an fiber placement head. Thus, a fiber application device may include or be entirely made up of an fiber placement head.

The positioner moves or articulates the fiber placement head into a location based upon a three-dimensional model having arbitrary directions which require the fiber application device to have multiple degrees of orientation and positioning, relative to the tool, mold or rotatable mandrel. In typical implementations, the controlling algorithms for such degrees of orientation or position are determined through a numerically controlled master program that directs through at least one controller located within the operator station of said positioner and notifies the fiber placement head when to initiate fiber tow or tape lay-up against the tool, mold or rotatable mandrel (hereinafter generally referred to as “the tool”). A separate set of software algorithms direct the fiber application device activities regarding the lay-up application based upon a universal axis point pre-determined by the shape or contour of the desired composite product. Once the fiber application software and apparatus engage in lay-up activities, the at least one controller controls positioning movements and fiber application events upon receipt of a signal from operator station. Upon completion of lay-up and notification from the operator station to the fiber application device and positioner of such, the positioner continues its dominant posture by maneuvering the fiber application device to the next programmed position as directed by the master controller from the operator station.

The common practice within the industry is to develop a software program that instructs a positioner controller to move the positioner and the fiber application device in accordance with a master CNC program design. Upon confirmation from the positioner that the correct presentation point has been arrived at, an input signal engages the fiber application device at the end of the positioner for the application of composite fiber tows of various widths and thickness in accordance with the same master CNC program for a prescribed number of plies until the requisite thickness is achieved.

During the fiber tow lay-up, the fiber placement head compresses the composite tows against the tool. A rotatable mandrel is one that simply rotates along a horizontally or vertically polar axis at a rate of speed defined and controlled by the CNC master program and directed in concert through the positioner controller. In some circumstances, a moderately passive tool may move along a limited or restricted pathway directly opposite the fiber placement head and compaction roller. However, the forms or shapes of products created from such are generally large, male or neutral designs, lacking any complex angles of application or acute contours.

Several problems exist in the current state of the art relating to fiber placement manufacturing apparatuses and methods. First, it is very important to initiate the fiber placement events at the desired time. For instance, one such event is the cutting of a tow at the end of a run of placement, such as at the edge of the tool, mold or mandrel. To initiate this event, the at least one controller must activate the cutting mechanism. However, latency will exist in the system due to controller lag as well as the amount of time it takes for the signal from the controller located at the base station to reach the fiber placement head which is typically significantly far, at least via wire, away from the base station that includes the controller.

A further issue in current fiber placement manufacturing apparatuses and methods is the way that tows are prepared for lay-up within the fiber placement device prior to being used by the fiber placement head. Typically, individual tows are stored on spools located in a climate controlled creel. Downstream from the creel but upstream or part of the fiber placement head the tow is passed through an active fiber redirect mechanism such as a dancer arrangement that is a plurality of movable pulleys that can take up a predetermined length of tow in a back and forth serpentine arrangement. As the tow is drawn from the dancer the pulleys move toward one another allowing tow to be drawn from the dancer without requiring more tow to be withdrawn from the actual spool. The dancer arrangement allows for a more controlled and consistent upstream tensioning of the tow as it is being drawn into the fiber placement head. Once the length of tow stored in the dancer arrangement drops below a predetermined level, the spool dispenses more tow into the dancer arrangement. In effect, the dancer arrangement can be seen as buffer area for the tow prior to fiber placement. It should be noted that an active fiber redirect mechanism could take the form of only a single pulley that can adjust its position to provide for a similar action, such as like an idler pulley.

By using the dancer arrangement, the control of the spool, i.e. when it dispenses more tool, can be entirely ignorant of the actual rate at which the tow is actually being applied to the tool, mold or mandrel as well as the location where the tow is being applied. Thus, the controllers that are typically used to control the dispensing of tow from the spools only monitor the amount of tow stored in the dancer arrangement.

Additional active fiber redirect mechanisms are used in fiber placement apparatuses. For instance, in some instances, a creel may be in a generally fixed position relative to a tool such with the fiber placement head or end effector being moved to place tow in varying locations. Such a fiber redirect mechanism is illustrated in U.S. patent application Ser. No. 11/510,165 to Hoffmann, filed Aug. 25, 2006, published as U.S. 2007/0044919 on Mar. 1, 2007, and assigned to the assignee of the instant application, the teachings and disclosure of which are incorporated herein by reference thereto.

The fiber redirect mechanism in Hoffmann allows for the fiber placement head to be pivoted through a significant pivot angle. This fiber redirect mechanism is necessary as the creel in that application is prevented from pivoting or rotating along with the fiber placement head about various polar axis therein. As such, in Hoffmann, when the fiber placement head pivots about various axis within the wrist mechanism thereof, the location of the compaction roller of the fiber placement head changes is orientation relative to the creel. As such, this creates a significant change in the tow path for individual tows as they travel from the spools within the creel to the fiber placement head generally and the compaction roller more specifically.

Unfortunately, the use any additional device to bend the tow prior to placement can result in degradation of the tow which can result in the tow fraying or otherwise fouling prior to placement. Fouling or fraying of the tow can result in either shutdown of the fiber placement device causing expensive delay and correction or alternatively result in an incomplete or improper tow placement which can result in a defect within the part being formed.

Further, in Hoffman, it can be seen that the tow paths for the individual tows from the creel to the fiber placement head experience a significant length of exposed travel between the creel and the fiber placement head providing for additional degradation or fouling to the fiber tows.

### BRIEF SUMMARY OF THE INVENTION

Embodiments of the present invention provide fiber delivery apparatuses for use in a fiber placement system that provide fixed tow paths along which tows travel from a fiber spool toward a fiber placement head and more particularly a compaction roller of/attached to the fiber placement head. This arrangement eliminates the need for any fiber redirect mechanisms that redirect the tow paths or take up tows as they are dispensed from the fiber spools.

In a more particular embodiment, a fiber delivery apparatus for the manufacture of composite fiber laminated products comprising an articulating wrist apparatus, a creel assembly, a fiber placement head and a compaction roller is provided. The articulating wrist apparatus includes first and second wrist elements operably coupled to one another for pivotable movement therebetween about a wrist articulation axis. The creel assembly stores a plurality of fiber spools therein. The creel assembly mounts to the second wrist element for rotation about the wrist articulation axis relative to the first wrist element. The fiber placement head mounts to the second wrist element. The fiber spools and fiber placement head are simultaneously rotatable relative to the second wrist element about a head rotation axis being perpendicular to the wrist articulation axis. The fiber placement head being maintained in a substantially fixed position relative to the fiber spools. The compaction roller is attached to the fiber placement head.

In one embodiment, a tow path between each of the plurality fiber spools and, at least, the fiber placement head is free of an active redirect mechanism (e.g. a dancer or a fiber redirect mechanism) between the fiber spools and the fiber placement head such that the tow paths maintain a substantially constant length. In a further embodiment, the tow paths maintain substantially constant in orientation.

The fiber delivery apparatus may include a connection arrangement for releasably coupling the fiber delivery apparatus to a positioner such that the creel assembly, wrist arrangement, fiber placement head and compaction roller form a complete module that may be attached and detached from a positioner. In one embodiment, the connection arrangement is rotatable relative to the first wrist element about a wrist rotation axis, the wrist rotation axis being perpendicular to the wrist articulation axis.

In one embodiment, the creel assembly includes a housing and a spool support structure within the housing. The spool support structure supports the fiber spools, the spool support structure being rotatable relative to the second wrist element about the head rotation axis in unison with the fiber placement head. This arrangement maintains a substantially fixed orientation between the fiber placement head (and more particularly the compaction roller) and the fiber spools. In more particular embodiments, the housing is fixed relative to the second wrist element and the spool support structure rotates within the housing. In some embodiments, the housing is fixed to or forms a part of the spool support structure and rotates therewith.

In one embodiment, at least a portion of the spool support structure is positioned on a first side of the wrist articulating axis and the compaction roller is on an opposite second side of the wrist articulating axis. More particularly, the compaction roller is on a first side of and at least one of the spools is on a second, opposite, side of a plane that is orthogonal to the head rotation axis and that includes the wrist articulation axis. This arrangement prevents the connection of the fiber delivery apparatus from being positioned at a distal end thereof such that the positioner device and the connection to the fiber delivery apparatus extends a length or footprint of the fiber delivery apparatus increasing the minimum size of a female cavity in which the combined fiber delivery apparatus may be used.

In a further embodiment, the compaction roller is axially spaced from at least one of the fiber spools along the head rotation axis. The wrist articulating axis is axially interposed along the head rotation axis between the at least one of the fiber spools and the compaction roller.

In one embodiment, the wrist rotation axis provides the only degree of freedom between the connection arrangement and the first wrist element. The wrist articulation axis provides the only degree of freedom between the first wrist element and the second wrist element. The head rotation axis provides the only degree of freedom between the second wrist element and the fiber placement head. Finally, the head rotation axis provides the only degree of freedom between the second wrist element and an axis about which each fiber spool rotates.

In one embodiment, the fiber delivery apparatus includes a tow path between each of the plurality fiber spools and, at least, the fiber placement head. Further, substantially the only degree of freedom between the portion of the tow paths between each of the plurality fiber spools and, at least, the fiber placement head is rotation about the head rotation axis.

In one embodiment, all components of the fiber delivery apparatus rotatable about the wrist articulation axis relative to the first wrist element lie within an imaginary boundary defined by a circle centered about the wrist articulation axis having a radius defined between the wrist articulation axis and the compaction roller. This arrangement allows the fiber delivery apparatus to be placed into a female cavity and rotated about the wrist articulation axis with less fear of contacting or engaging a surface of a female tool.

The apparatus of claim 1, further comprising a tow path between each of the plurality fiber spools and, at least, the fiber placement head, wherein the entire portion of the tow paths extending between the fiber spools and the fiber placement head is entirely internal to the fiber delivery apparatus.

In a further embodiment of the invention, a fiber delivery apparatus including an articulating wrist, a creel assembly, a fiber placement head and a compaction roller is provided that is configured to balance the foot print of the apparatus on opposite sides of a wrist articulation axis to increase operability within smaller female tools. The articulating wrist apparatus includes first and second wrist elements operably coupled to one another for pivotable movement therebetween about a wrist articulation axis. The creel assembly stores a plurality of fiber spools therein. The creel assembly mounts to the second wrist element for rotation about the wrist articulation axis relative to the first wrist element. The fiber placement head mounts to the second wrist element. The fiber placement head is maintained in a substantially fixed position relative to the fiber spools. The compaction roller attaches to the fiber placement head. The compaction roller is always axially spaced from at least one of the fiber spools along an offset axis that is generally perpendicular to both the wrist articulation axis and an axis of rotation of the compaction roller and the wrist articulating axis is axially interposed along the offset axis between the at least one of the fiber spools and the compaction roller.

In a more particular embodiment, all components of the fiber delivery apparatus rotatable about the wrist articulation axis relative to the first wrist element lie within an imaginary boundary defined by a circle centered about the wrist articulation axis having a radius defined between the wrist articulation axis and the compaction roller. In a more preferred embodiment, the tow path between the plurality of fiber spools and the fiber placement head is fixed in length and orientation and free of a fiber redirect mechanism for transitioning the tow path between differently shaped paths.

A further embodiment of the invention provides a fiber delivery apparatus for the manufacture of composite fiber laminated products including a plurality of fiber spools therein and a fiber placement head in a fixed relationship to the fiber placement spools such that tow paths between the fiber spools and the fiber placement head are substantially fixed in length and substantially fixed in orientation.

In a more preferred embodiment, the fiber delivery apparatus is free of any fiber redirect mechanism along the tow paths between the fiber spools and the fiber placement head. In an even more preferred embodiment, the fiber delivery apparatus includes at least one static guide device along each tow path altering a direction in the tow path, the alteration in direction being a fixed alteration such that the static guide device is not considered a fiber redirect mechanism.

One embodiment of the present invention is in which both the fiber delivery system, which replaces the customary fiber application device role, and the tool, mold or rotatable mandrel, each remain in a static, non-manipulated, non-articulated relationship during the lay-up process, wherein, such lay-up is achieved as directed by a software program direction, generated internally from the fiber delivery system alone.

Another aspect of an embodiment of the present invention is one in which either the fiber delivery system, or the tool, mold or rotatable mandrel, have limited motions, independent of one another, or in concert, either simultaneously or reciprocally, as directed by the software program direction, generated internally from the fiber delivery system alone.

In yet another aspect of an embodiment of the present invention is one in which the fiber delivery system operates and moves entirely independently of the tool, mold or rotatable mandrel, which remains in a fixed or static position, relative to the fiber delivery system, as directed by the software program direction, generated internally from the fiber delivery system alone.

In yet another aspect of an embodiment of the invention, the fiber delivery system contains within its physical structure all the hardware and software programming for both the delivery of composite fiber tows to a surface during lay-up, as well as kinematic algorithms and Cartesian spatial interpretation of the tool, mold or rotatable mandrel, relative to the constant positioning of the fiber delivery system. This self-contained, intelligent fiber delivery system may be detachably secured to any manipulative device, such as a robotic arm, a multi-axial milling machine spindle or ram, in either a horizontal or vertical presentation, or an existing fiber placement machine.

In yet another aspect of an embodiment of the invention, the complete product kinematics, any Cartesian positioning instructions, or fiber tow delivery specifications, may be contained within the fiber delivery system, detachably secured to a fixed position device, whereupon the tool, mold or rotatable mandrel, may move in relation to the fiber placement head or compaction roller, for the placement of composite fiber tows, within a limited range as determined by the product design or configuration. The tool, mold or rotatable mandrel may be detachably secured to a simple robotic manipulation system that is responsive to the Cartesian positioning instructions without any knowledge or awareness of the composite tow lay-up functions, or governance by a separate controller guided by a network or other system.

In one version an embodiment, the fiber delivery system is detachably secured to a platform or apparatus through an interface having an internally mounted drive apparatus responsive to the fiber delivery system containing within its physical structure all the hardware and software programming for both the delivery of composite fiber tows to a surface during lay-up, as well as kinematic algorithms and Cartesian spatial interpretation of the tool, mold or rotatable mandrel, relative to the constant positioning of the fiber delivery system.

In yet another aspect of an embodiment of the invention, the fiber delivery system is detachably secured to a platform or apparatus interface that does not have any separate or dedicated means of movement, manipulation or articulation, relative to the positioning of a tool, mold or rotatable mandrel.

Accordingly, an embodiment, the self-contained fiber delivery system, having the complete product kinematics, the Cartesian positioning instructions and the fiber tow delivery specifications contained within, may move unilaterally in relation to the tool, mold or rotatable mandrel, which may be mounted on a rotatable or articulating platform, yet require no movement, manipulation or articulation to complete the desired product design or configuration. The absence of need for a coordinating or reciprocal movement by the tool, mold or rotatable mandrel, relieves the manufacturer of the time and expense of creating or modifying or synchronizing any hardware or software controlling the tool, mold or rotatable mandrel for its use in the manufacture of the desired product design or configuration.

Accordingly, in one an embodiment, the fiber delivery system has a self-contained creel assembly, having a thermostatically controlled atmosphere, bearing multiple composite fiber tow spindles in a parallel presentation that dispense tows directly to a compaction roller fiber placement head without reliance upon or integration of any active fiber redirect mechanism.

In another embodiment, a composite fiber delivery system for the manufacture of composite fiber laminated products is provided. The system includes a self-contained creel assembly having a creel including therein at least two spools of fiber tow material, an fiber placement head, and a compaction roller attached to the fiber placement head. The system also includes a positioner for positioning the self-contained creel assembly a tool, mandrel or mold relative to one another.

In one embodiment, the spools of fiber tow material have axes of rotation that are parallel to an axis of rotation of the compaction roller of the fiber placement head. Tow paths from each of the at least two spools to the compaction roller are free of an active redirect mechanism such as a dancer arrangement or idler pulley arrangement such that the tow material travels along a substantially direct path with only minimal, if any, redirect from the spools to the fiber placement head.

In one embodiment, the self-contained creel assembly further includes an internal autonomous controller mounted therein. The internal autonomous controller has direct interactive communications with an external positioning controller for controlling the positioner. The internal autonomous controller directs at least one fiber placement event, such as cutting, adding, inspection, heating, compaction, or tensioning of fiber tow during application onto a stationary or moving tool, mold or mandrel surface.

The self-contained creel assembly and positioner may have a cooperating mechanical interface by which the self-contained creel assembly may be detachably secured to the positioner. Further, the self-contained creel assembly may remain in a static position during fiber tow application while a positioning controller of the positioner directs the movements of positioner to position the tool, mold or mandrel relative to the static self-contained creel assembly. The mechanical interface may include at least one external servo motor or motivational mechanism dedicated to the articulation of creel assembly along a multi-axial connection.

The self-contained creel assembly may be an articulating self-contained creel assembly delivery mechanism including a pivoting joint pivoting about an axis that is interposed between at least one of the fiber spools and the fiber tow compaction roller.

In embodiments including an internal autonomous controller mounted in the self-contained creel assembly, the internal autonomous controller controls at least one fiber application event of the fiber placement head. The internal autonomous controller may control the at least one fiber application event based on a CNC master design loaded therein. The internal autonomous controller may also control the at least one fiber application event based on the CNC master design as well as positional information provided from the positioner, and more preferably provided from a controller of the positioner. The positional information may be a speed of the movement of the compaction roller along a tow path to initiate the fiber application (or placement) event. This speed may be along one axis and not the actual speed of the device.

In a further embodiment, the positioner controller is external to the self-contained creel assembly and the positioner controller controls the positioner based on the CNC master design. The system may further includes a creel controller. The creel controller is separate from the positioner controller and the internal autonomous controller. The creel controller controls at least one creel parameter based on the CNC master design. The creel parameter may be the feed rate of fiber material from at least one of the at least two spools or it may be the tension of fiber material just as it is being dispensed from at least one of the at least two spools.

In another embodiment of the invention, a self-contained creel assembly is provided. The self-contained creel assembly includes a conditioned creel having at least two spools of fiber material. Each spool coupled to a drive mechanism, such as a motor and more particularly a brushless motor, for controlling dispensing of the material from the spool. A creel controller operably couples to the drive mechanisms and is configured to control the dispensing of the material based on a CNC master design. Each spool may have its own controller. In one embodiment, the creel controller is further configured to control the dispensing of the material based further on positional information of the self-contained creel assembly relative to a tool, mandrel or mold. Further yet, the self-contained creel assembly may include a separate internal autonomous controller for controlling fiber placement head events of an fiber placement head of the self-contained creel assembly based on a CNC master design of the part to be formed.

The creel controller may or may not be part of an internal autonomous controller mounted within the self-contained creel assembly. The self-contained creel assembly may include an fiber placement head that performs the fiber placement events. The paths of the material between the spools and the fiber placement head being free of any dancer arrangement or an idler pulley arrangement or other active redirect mechanism.

Preferably, the path from the spool to the fiber placement head in embodiments is less than 5 feet and preferably less than 3 feet.

In a further embodiment, an apparatus for a composite fiber delivery system for the manufacture of composite fiber laminated products is provided. The apparatus includes a self-contained creel assembly having at least two spools of fiber tow material. The self-contained creel assembly includes a fiber placement delivery mechanism including a fiber tow compaction roller attached to the fiber placement head. The at least two spools have an axis of rotation that is parallel to an axis of rotation of the fiber tow compaction roller of the fiber placement head. The fiber tow material travels along paths extending directly from the corresponding spool to the fiber placement head without interference or influence by an active fiber redirect mechanism, but may have minor redirection from substantially fixed position redirectors. The apparatus also includes an internal autonomous controller receiving positional information from an external positioning controller. The internal autonomous controller controlling the fiber placement events, such as the cutting, adding, inspection, heating, compaction, or tensioning of fiber tow, during application tool, mold or mandrel. The internal autonomous control controlling based on a CNC master design and potentially positional information of at least one component of the self-contained creel assembly.

The apparatus may include a creel controller controlling creel events such as displacement of material from the at least two spools. The internal autonomous controller and creel controller are mounted on, such as within, the self-contained creel assembly and the internal autonomous controller, creel controller and positioner controller control their respective devices based on a CNC master design. Further, the internal autonomous controller and creel controller receive positioning information from the positioner to further facilitate control of their respective devices.

The self-contained creel assembly includes articulating joint located between the fiber tow spools and the fiber tow compaction roller.

In another embodiment, a method of controlling fiber placement from a self-contained creel assembly onto a tool, mold or mandrel is provided. The method including the step of dispensing fiber material from a spool of a creel of the self-contained creel assembly based on a known position of the self-contained creel assembly relative to the tool, mold or mandrel.

A preferred method includes passing the fiber material along a fixed tow path. The fixed to path is fixed because it is free of active fiber redirect mechanisms but may include passive redirects such as fixed position pulleys or fixed position bars.

The method may further comprise the step of receiving positional information from a positioner that positions the self-contained creel assembly and the tool, mold or mandrel relative to one another, wherein the step of dispensing includes dispensing material based on analysis of positional information in concert with a CNC master design to actively control the dispensing of the fiber material from the spool.

The step of dispensing may include controlling the rate at which the fiber material is dispensed based, at least in part, on a CNC master design. The step of dispensing may also include adjusting the rate of dispensing to adjust a tension of the dispensed fiber material based, at least in part, on a CNC master design.

In one form of the method, the method further includes receiving the CNC master design by a creel controller that controls the step of dispensing and further comprises receiving the CNC master design by an internal autonomous controller mounted on the self-contained creel assembly and further comprises the step of controlling additional fiber placement events. The creel controller controls the step of dispensing simultaneously as the internal autonomous controller controls the additional fiber placement events.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an embodiment of a fiber placement system according to the present invention including a fiber delivery apparatus detachably secured to a vertical ram and operating against a static male tool;

FIG. 2 is a simplified partial cross-sectional illustration of the fiber delivery apparatus of FIG. 1;

FIG. 3 is a simplified exploded illustration of the fiber delivery apparatus of FIG. 2;

FIGS. 4 and 5 are simplified side schematic illustrations of the fiber delivery apparatus of FIG. 1 relative to a female tool;

FIG. 6 is a simplified isometric illustration of a creel assembly and fiber placement head according to an embodiment of the present invention illustrating a fixed tow path from fiber spools of the creel assembly to the fiber placement head;

FIG. 7 is a further simplified illustration of the fiber delivery apparatus of FIG. 1 in an exploded view;

FIG. 8 is a simplified cross-sectional illustration of an embodiment of a spool support structure;

FIG. 9 is further embodiment of a fiber placement system including a fiber delivery apparatus detachably secured to a vertical ram and operating against a static female or concave tool having a interior surface configuration of multiple contoured radii and elevations as well as both an acute and broad range of concavity;

FIG. 10 is a simplified schematic illustration of the fiber delivery apparatus of FIG. 9;

FIG. 11 is an embodiment of a fiber placement system including a fiber delivery apparatus detachably secured to a stationary storage bracket in relation to a fixed position mold or tool detachably secured to an articulating positioner;

FIGS. 12 and 13 are simplified schematic illustrations of potential control arrangements for controlling fiber delivery apparatuses according to the present invention;

FIGS. 14 and 15 are further simplified illustrations of fiber delivery apparatuses according to the present invention;

FIG. 16 is a simplified side view illustration of an embodiment of a fiber delivery apparatus similar to that of FIG. 9 for use in small female tools; and

FIGS. 17 and 18 are simplified side view illustrations of the fiber delivery apparatus of FIG. 16 within a female tool.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

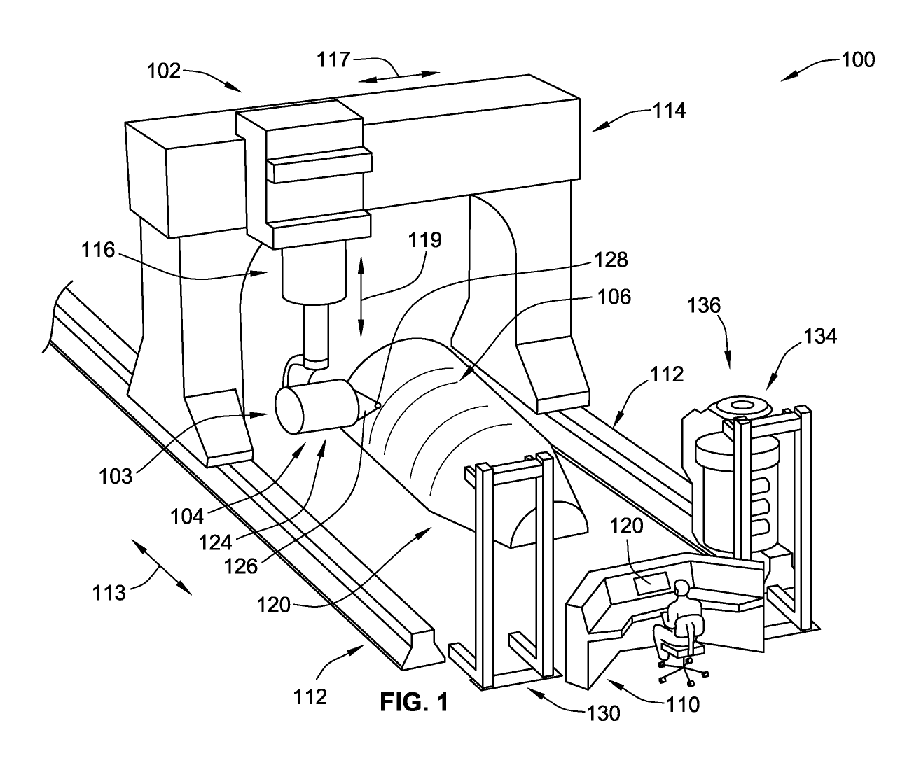

FIG. 1 illustrates an embodiment of a fiber placement system 100 according to an embodiment of the present invention. The fiber placement system 100 generally includes a gantry system 102 and a fiber delivery apparatus 103 (also referred to as a “creel and fiber placement head assembly”) including a self-contained creel assembly 104 (hereinafter creel assembly 104) and a fiber placement head 105. The fiber placement system 100 is used to layup fiber tows onto tool 106 to form composited parts. The gantry system 102 provides, at least, three linear degrees of freedom for linearly positioning the fiber delivery apparatus 103 and particularly the fiber placement head 105 thereof relative to the tool 106. The fiber placement system 100 and its components, where applicable, can be controlled by computer front end station 110.

The gantry system 102 generally provides for at least three axis of linear motion for linearly positioning the creel assembly 104 relative to tool 106. The gantry system 102 includes a base 112 including parallel tracks providing linear movement along a first linear axis 113. A horizontal gantry 114 is supported by the parallel tracks of base 112 and is mechanically driven along the base 112. The horizontal gantry 114 supports a vertical ram 116 of the gantry system 102. The horizontal gantry 114 provides linear horizontal movement to the vertical ram 116 along a second linear axis 117 that is perpendicular to the first linear axis 113 defined by the parallel base 112. The vertical ram 116 provides a linear vertical degree of freedom to the gantry system 102 along a third linear axis 119 that is generally perpendicular to the first and second linear axes 113, 117. It should be noted that in a preferred embodiment the first, second and third linear axes 113, 117, 119 are perpendicular to one another. However, the invention is not so limited and other gantry system arrangements can be provided. Further yet, the gantry system could be replaced by a multi-degree of freedom robot, typically referred to as a SCARA robot.

The execution of various events relevant to the fiber placement system 100, the gantry system 102 and the ram 116, and fiber delivery apparatus 103, are monitored by an operator at the computer front end station 110, and displayed to the operator through a operator interface station 112 as directed by a CNC master design of the end part that is formed on tool 106, which is typically supplied from a database server system.

Attached to the vertical ram 116, is one embodiment of a fiber delivery apparatus 103. The fiber delivery apparatus 103 generally includes creel assembly 104 and a fiber placement head 105 for fiber tow lay-up. The creel assembly 104 includes a creel 124. The creel 124 is a climate controlled environment in which spools of fiber tow are stored. Within the creel 12 are further components of the creel assembly 104 that assist in dispensing and directing the fiber tows to the fiber placement head 105. Typically, as will be more fully discussed below, a plurality of spools are stored in the creel 124. In larger embodiments, the creel 124 can store in excess of 16 spools while smaller embodiments may include only 4 or 8 spools within the creel 124 so as to reduce the overall footprint of the fiber delivery apparatus 103.

The fiber placement head 105 performs the necessary operations to the fiber tows or tool 106 to layup (also referred to as lay down) the fiber tows onto the tool 106. The fiber placement head 105 typically includes a compaction roller 128 and other components used for fiber lay-up which may include heaters for heating the tows or the tool 106, visual inspection devices, tow cutters, etc. The compaction roller 128 is typically considered part of the fiber placement head 105, but in some embodiments may not be considered part of the fiber placement head 105. A portion of fiber placement head 105 may or may not be positioned in a portion of creel assembly 104 or creel 124. This is one embodiment of the fiber delivery apparatus 103.

As can be understood from FIG. 1, the entire fiber placement apparatus 103 is positionable along the three linear axes 113, 117, 119 relative to tool 106.

As compared to other fiber placement systems, such as Hoffmann discussed above, because the creel 124 is positioned at the end of and carried by the vertical ram 116 rather than mounted above and to the horizontal gantry 114, the distance between individual spools (internal to the creel 124) and the fiber placement head 105 and more particularly compaction roller 128 is significantly reduced. Further, the tow paths between the spools and the fiber placement head 105 defined by the individual tows is substantially if note entirely housed within the creel assembly 104 such that the fiber tows are not exposed or only exposed for a limited time to the operating environment until they are being placed using the compaction roller 128. This significantly reduces the opportunity for fouling or otherwise damaging the tows.

Further, because the creel assembly 104 and particularly the creel 124 thereof and the fiber placement head 105 form part of the fiber delivery apparatus and are carried at the end of ram 116, the length of the tow path between the spools and the fiber placement head remains constant. In Hoffman, as the ram moved down, the length of the tow path increased from the spools to the fiber placement head and when the ram moved up, the length of the tow path decreased from the spools to the fiber placement head.

As shown in FIG. 1, the creel assembly 104 is positioned as shown in an application mode, applying fiber tows onto a stationary tool 106. Tool 106 in this embodiment is in the form of a male tool. When not in use, the fiber delivery apparatus 103 may be stored on either stationary storage bracket 130 or 132. In this embodiment, a second, reserve, fiber delivery apparatus 134 is provided in furtherance of the fiber placement system 100's interchangeability feature that allows for changing between different fiber delivery apparatuses. Both fiber delivery apparatuses 103, 134 may be detachably secured to the vertical ram 116 by means of a mechanical interface 136. This mechanical interface can provide for automated interchangeability. For instance, a clamp arrangement may be used that automatically disengages and engages. Alternatively, a threaded or magnetic coupling could be used to couple the fiber delivery apparatuses 103, 134 to the ram 116. Other couplings are contemplated to provide for interchangeability and disconnection of the fiber delivery apparatuses 103, 134 from ram 116.

In this embodiment, the operations and creel content status may be reported to the operator station 110 by means of the system's status display 120.

Different ones of the fiber delivery apparatuses 103, 134 (and others as discussed below) can be used as reserves such that when the fiber delivery apparatus runs out of fiber, a second fiber delivery apparatus is ready to continue fiber layup. Alternatively, different ones of the fiber delivery apparatuses can provide different fiber layup characteristics and can be used for different tool shapes or sizes. For instance, one fiber delivery apparatus may be better suited for smaller concave parts (e.g. a nose cone of an airplane) because it has fewer spools and a smaller compaction roller and get into concave cavities having tighter dimensions. A larger fiber delivery apparatus with greater storage capacity and more spools or a wider compaction roller may be used to increase speed of layup such as when applying tows across a relatively simple and large geometry (e.g. a wing of an airplane).

In the instant embodiment, it is a feature of the creel assembly 104 that the tow path, i.e. the path the fiber tows travel from a fiber spool 140 to the fiber placement head 105 is substantially constant with little to no variation in length or direction. This is effectuated in the instant embodiment, because the fiber placement head 105 and the fiber spools 140 within creel 124 remain in a substantially constant orientation and position relative to one another during all positioning actions of the fiber placement head 105. As such, when the fiber placement system 100 adjusts the orientation of the fiber placement head 105 relative to a tool 106, the spools 140 are similarly oriented and maintain in a constant orientation relative to fiber placement head 105.

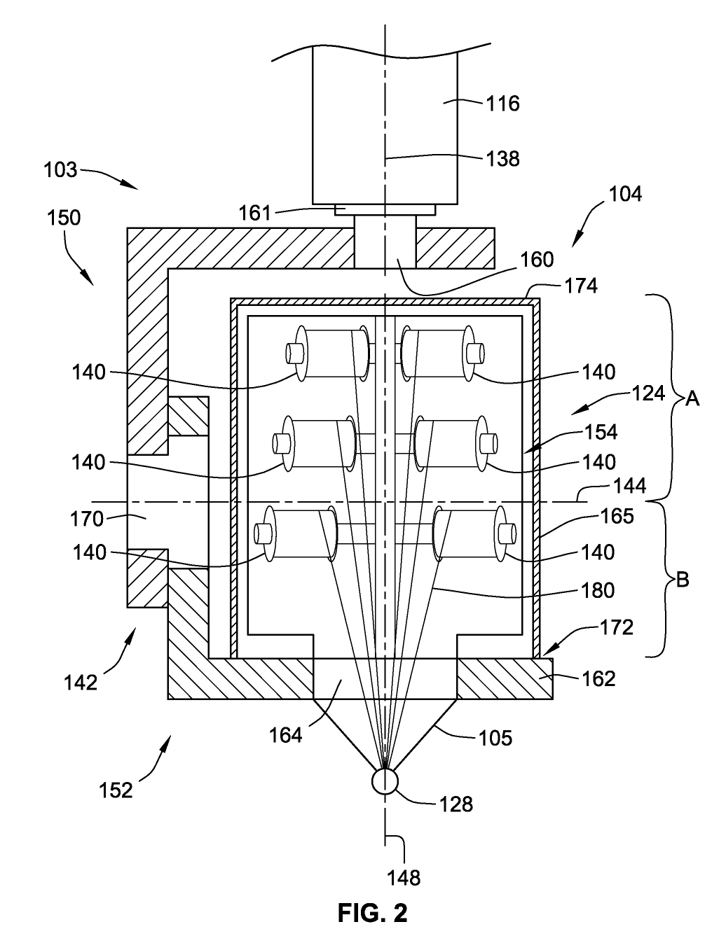

FIG. 2 is a simplified illustration of the fiber delivery apparatus 103 attached to an end of vertical ram 116. In this embodiment, the interface between the fiber delivery apparatus 103 and the vertical ram 116 provides a first rotational degree of freedom to the fiber placement system 100. More particularly, the fiber delivery apparatus 103 is allowed to rotate about first rotational axis 138 relative to ram 116. Rotation about axis 138 causes, at least, the fiber spools 140 within creel 124, fiber placement head 105 and compaction roller 128 to all simultaneously rotate about first rotational axis 138. Typically, the entire creel assembly rotates in unison about first rotational axis 138.

The fiber delivery apparatus 104 further includes an articulating wrist apparatus 142 to which creel assembly 104 and fiber placement head 105 are mounted. The articulating wrist apparatus 142 is rotated about first rotational axis 138. Because the creel assembly 104 and fiber placement head 105 are mounted to the articulating wrist apparatus 142, this rotation about axis 138 effectuates rotation of the creel assembly 104, fiber placement head 105 and compaction roller 128 about first rotational axis 138.

The articulating wrist provides an articulating joint that provides a second rotational degree of freedom to the fiber placement system 100. More particularly, the articulating wrist apparatus 142 allows, at least, the spools 140, the fiber placement head 105 and compaction roller 128 to be rotated about second rotational axis 144. Typically, the entire creel assembly 104 and the fiber placement head 105 are rotated about second rotational axis 144 via the articulating joint provided by the articulating wrist apparatus 142. This second rotational axis 144, in the preferred embodiment, is generally perpendicular to the first rotational axis 138.

The fiber delivery apparatus 103 also provides a third rotational degree of freedom to the fiber placement system 100. The spools 140 are mounted within creel 124 such that they are allowed to rotated relative to the articulating wrist apparatus 142 about third rotation axis 148. Similarly, the fiber placement head 105 is operably mounted such that it rotates about third rotational axis 148. The rotation of the spools 140 and fiber placement head 105 is simultaneous such that the orientation of the fiber placement head 105 relative to the fiber spools 140 does not change due to rotation of either about third rotational axis 148.

The third rotational axis 148 is generally perpendicular to the second rotational axis 144. As such, the first and third rotational axes 138, 148 change in angular relation to one another due to rotation about second rotational axis 144.

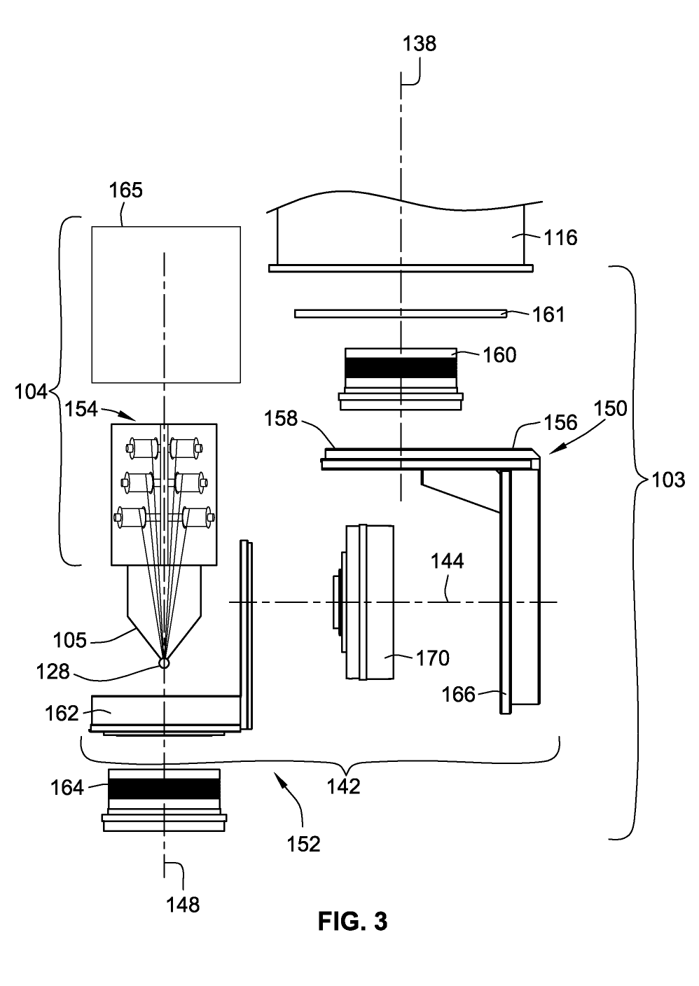

FIG. 3 illustrates the fiber delivery apparatus 103 partially exploded. As illustrated therein, The articulating wrist apparatus 142 includes a first and a second wrist element 150, 152 thereof, operatively connected to one another, and adapted for operatively connecting the creel assembly 104 and fiber placement head 105 to vertical ram 116.

The first wrist element 150 has a base 156 having a mounting surface 158 adapted to face vertical ram 116. A wrist rotation torque motor 160 operably rotationally drives the base 156 relative to the ram 116. One portion of the wrist rotation torque motor 160 is coupled to the base 156. A mounting plate 161 may be connected to another portion of the wrist rotation torque motor 160, that rotates relative to the portion of the wrist rotation torque motor that is coupled to the base 156. The mounting plate is then connectable to cooperating structure of the vertical ram 116 to facilitate rotation of the fiber delivery apparatus 103 about first rotational axis 138. Alternatively, the mounting plate could be eliminated and other structure of operatively coupling the fiber delivery apparatus 103 to the vertical ram may be provided. E.g. a different portion of wrist rotation torque motor 160 may couple to vertical ram 116. However, the wrist rotation torque motor will be connected between that connection structure and the first wrist element 150 to rotate the first wrist element 150 relative to the connection structure for connecting the fiber delivery apparatus 103 to vertical ram 116.

The first wrist element 150 and wrist rotation torque motor 160 define the first rotational axis 138, with the mounting surface 158 of the base 156 of the first wrist element 150 extending substantially perpendicularly to the first rotational axis 138. This first rotational axis 138 may also be referred to as a wrist rotation axis 138. The wrist rotation torque motor 160 rotates substantially all of the fiber delivery apparatus 103 about first rotational axis 138 (except for the connection structure and the portion of the motor 160 connected thereto).

The second wrist element 152 has a base 162 thereof that supports and is operably fixedly connected to a head rotation torque motor 164 that is operably coupled to spool storage cartridge 154 and fiber placement head 105 to operably rotationally drive the spool storage cartridge 154 and fiber placement head 105 about third rotational axis 148 (also referred to as head rotation axis 148). The head rotation torque motor 164 is mechanically interposed between base 162 and the fiber placement head 105/spool storage cartridge 154.

In this embodiment, only portions of the creel assembly 104 are rotated about third rotational axis 148 by head rotation torque motor 164 relative to the second wrist element 152. The outer housing 165 of the creel assembly 104 does not rotate relative to the second wrist element 152. The housing 165 of the creel assembly 104 remains fixed relative to base 162 and the second wrist element 152. Only parts of the creel assembly 104, such as the spool storage cartridge 154 (and consequently the spool 140 supported thereby and the corresponding directing structure directing tows from the spools 140 to the fiber placement head 105) rotate relative to the second wrist element 152 about head rotation axis 148, via head rotation torque motor 164. Further, the spool storage cartridge 154 of the creel assembly 104 is operably mechanically coupled to the fiber placement head such that the two components wrote simultaneously about third rotational axis 148 and otherwise remain in substantially a fixed relative orientation due to any movements of the fiber delivery apparatus to present the fiber placement head 105 to a tool 106.

The creel assembly 104 is generally the components that store and dispense the fiber tows to the fiber placement head 105. As such, the creel assembly 104 includes an outer housing 165 that provides a generally climate controlled environment for storing the fiber spools 140. As noted above, in some embodiments the outer housing 165 is fixed relative to the first wrist element 150.

The creel assembly 104 also includes the spool storage cartridge 154 that holds the fiber spools 140. The spool storage cartridge 154 is housed within housing 165. The spool storage cartridge is permitted to rotate within housing 165 about third rotational axis 148. The creel assembly 104 also includes any additional structures such as for non-limiting example generally fixed position rollers, guide bars or guide pins for defining the fixed tow path from the spools 140 to the fiber placement head 126 along which the fiber tows travel.

In FIGS. 2 and 3, the spool storage cartridge 154 is shown schematically including a rectangular box. The spool storage cartridge 154 does not need to include surrounding box or housing, but the box is used to illustrate a complete assembly of components that rotate together via head rotation torque motor 164 relative to second wrist element 152. Alternative, the storage cartridge 154 could be just a frame structure housed within housing 165 of creel 124 to which the spools 140 are mounted. Further yet, the frame structure could be in the form of the tree arrangement with a plurality of outward extending branches as illustrated in FIG. 2. Alternatively, the frame structure could be in the form of a housing in which the spools are mounted on spindles or servo motors that extend radially inward from an outer housing. In any event, the frame structure rotates about third rotational axis 148 with fiber placement head 105 to prevent the need of any fiber redirect mechanisms.

The first and second wrist elements 150, 152 are generally L-shaped, single tined forks. The first wrist element 150 has support arm 166 extending substantially perpendicularly from base 156 of the first wrist element 150 and generally parallel to first rotational axis 138. In similar fashion, the second wrist element 152 has support arm 168 extending substantially perpendicularly from the base 162 of the second wrist element 152 and generally parallel to third rotational axis 148. Support arms 166, 168 rotate about second rotational axis 144 within planes that are generally parallel, if not coplanar, to one another. Also, the first and third rotational axes 138, 148 are parallel to these planes in which the support arms 166, 168 rotate.

The support legs 166 are operatively rotationally joined by, at least, the wrist articulating torque motor 170 for relative pivotable movement of the first and second wrist elements 150, 152 with respect to one another about common second rotational axis 144 (also referred to as the wrist articulation axis 144). More particularly, one portion of the wrist articulating torque motor 170 is fixedly attached to support arm 166 of the first wrist element 150 and a second portion of the wrist articulating torque motor 170 is fixedly attached to support arm 168 of the second wrist element 152. The first and second portions of the wrist articulating torque motor 170 rotate relative to one another about a common axis that is coaxial with second rotational axis 144.

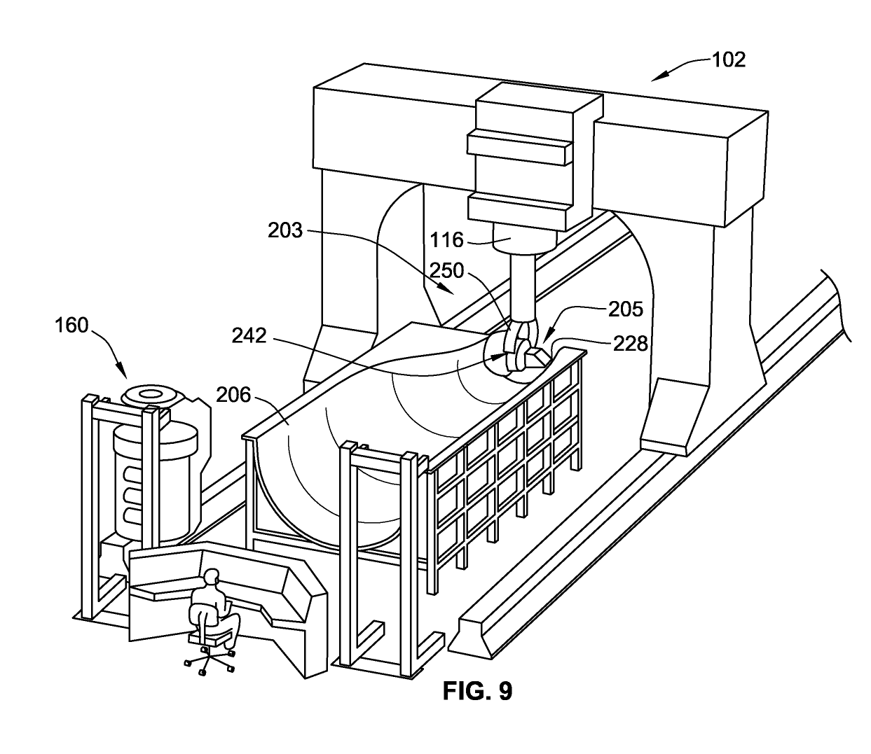

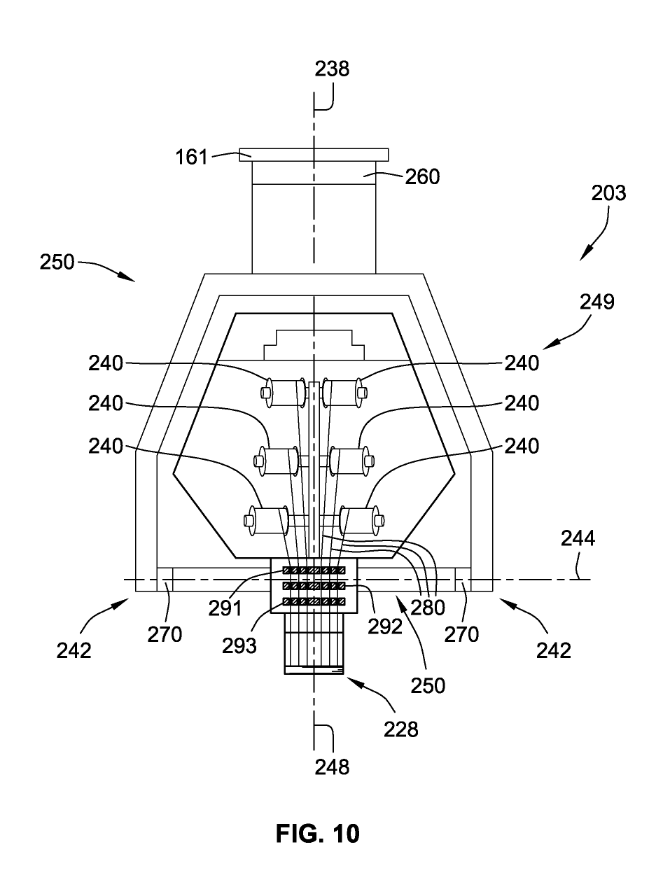

With additional reference to FIG. 2, second rotational axis 144 divides the combination of the creel assembly 104 and the fiber placement head 105 (referred to generally herein as a “fiber dispensing module”) into two potions A, B on either side of the second rotation axis 144. More particularly, some of the fiber spools 140 within the housing 165 of creel 124 are on one side of the second rotational axis 144 while, at least, the compaction roller 128 is on the opposite side of the second rotational axis 144. Creel 124 has a first end 172 proximate to base 162 and a second, distal, end 174, opposite first end 172, on the other side of the second rotational axis 144. In some embodiments, see FIG. 10, all of the spools are on one side of the rotational axis opposite the side on which the compaction roller is provided. Further, it is preferred that the majority of the length of the fiber placement head be positioned on the same side of axis 144 as the compaction roller in some embodiments.

The tow path, i.e. the path each tow travels from its spool 140 to the fiber placement head 105 generally and the compaction roller 128 more specifically remains substantially constant as the first and second wrist elements 150, 152 articulate relative to one another about second rotational axis 144.

The connection between the base 162 of the second wrist element 152 and the spool storage cartridge 154 and the fiber placement head 105 is positioned between at least one of the fiber spools 140 and the fiber placement head 105 or at least the compaction roller 128.

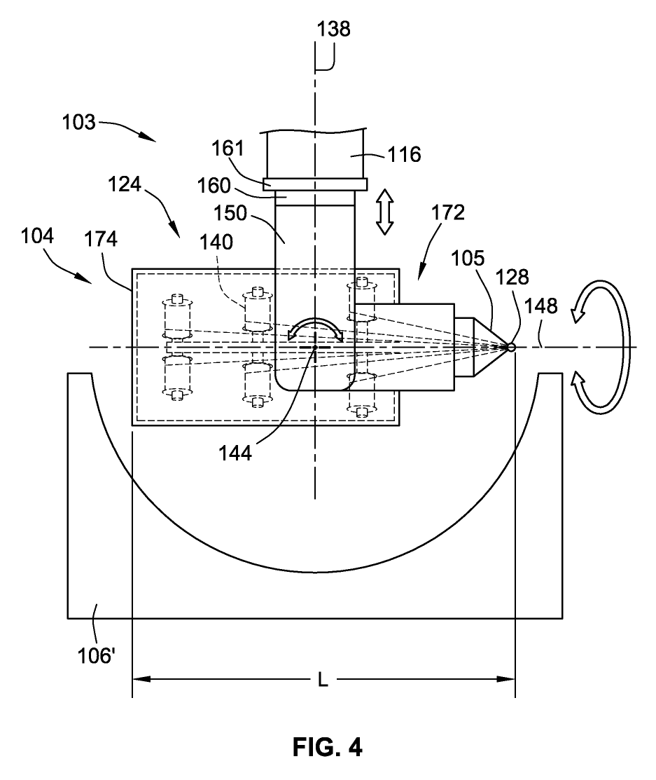

As illustrated in FIG. 4, the arrangement of the location of the second rotational axis 144 between the compaction roller 128 and the distal end 174 of creel 124 allows the fiber dispensing module (creel assembly 104 and fiber placement head 105) to be oriented such that the length L of the creel assembly 104 is defined by the distal end 174 of creel 124 and compaction roller 128. This is in the orientation where the first and third rotational axes 138, 148 are oriented perpendicular to one another.

In some prior art devices, the connection of the gantry system to the fiber placement head is positioned at an end of the fiber placement/creel assembly opposite the compaction roller such that the connection increases the width/length of the assembly. This increases the overall length of the device preventing it from being used within concave tool arrangements, such as tool 106′ in FIG. 4. As shown in FIG. 4, none of the connection components such as the first and second wrist elements 150, 152 extend outward along the third rotational axis beyond either end 174 of creel 124 or compaction roller 128. As such, as used herein, the connection between the components and the positioner, i.e. ram 116 is always positioned between the end of the creel assembly 104 and the compaction roller 128 and more preferably between the creel assembly and the fiber placement head 105. As such, the connection to the positioner does not provide additional undesirable length L to the fiber dispensing module.

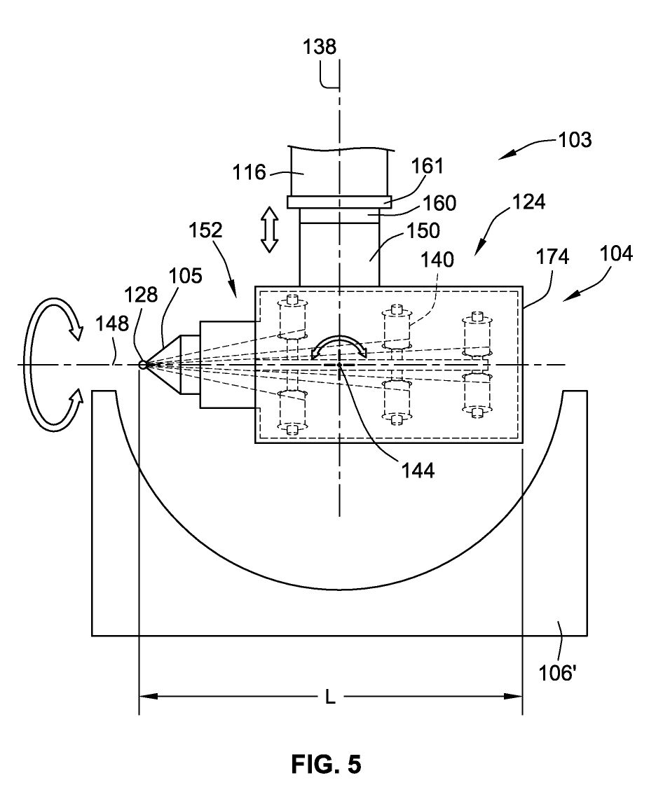

FIG. 5 illustrates the fiber placement head oriented in a horizontal position (horizontal position is used for illustrative purposes only) with the first and third rotational axes 138, 148 oriented perpendicular to one another due to the particular relative orientation of the first and second wrist elements 150, 152 about the second rotational axis 144. As illustrated in FIG. 5, the second rotational axis 144 is positioned between distal end 174 of creel 124 and compaction roller 128/fiber placement head 105. In preferred embodiments, L is less than 4 feet and more preferably less than 2 feet.

During operation, the compaction roller 128 is positioned relative to a surface of a tool by manipulating the position of the compaction roller 128 using gantry system 102 and the three rotational axes 138, 144, 148 that are built into the fiber delivery apparatus 103. Further, while the compaction roller 128 is manipulated through the various degrees of freedom provided by the fiber placement system 100, the tow path (illustrated only generically in FIGS. 2-8) from a given fiber spool 140 to the fiber placement head 105 remains substantially the same in length and direction. This is because the fiber placement head 105 has a substantially fixed orientation relative to the various fiber spools 140.

Because the spool storage cartridge 154, fiber placement head 105 and compaction roller 128 move in unison during position of the compaction roller 128, the fiber delivery apparatus 103 is free of any active fiber redirect mechanism required in prior systems to allow the fiber placement head to pivot relative to the creel 124 as well as to compensate for variations in tow path length due to vertically positioning the fiber placement head relative to a creel and particularly the fiber spools within the creel, such as illustrated in Hoffmann.

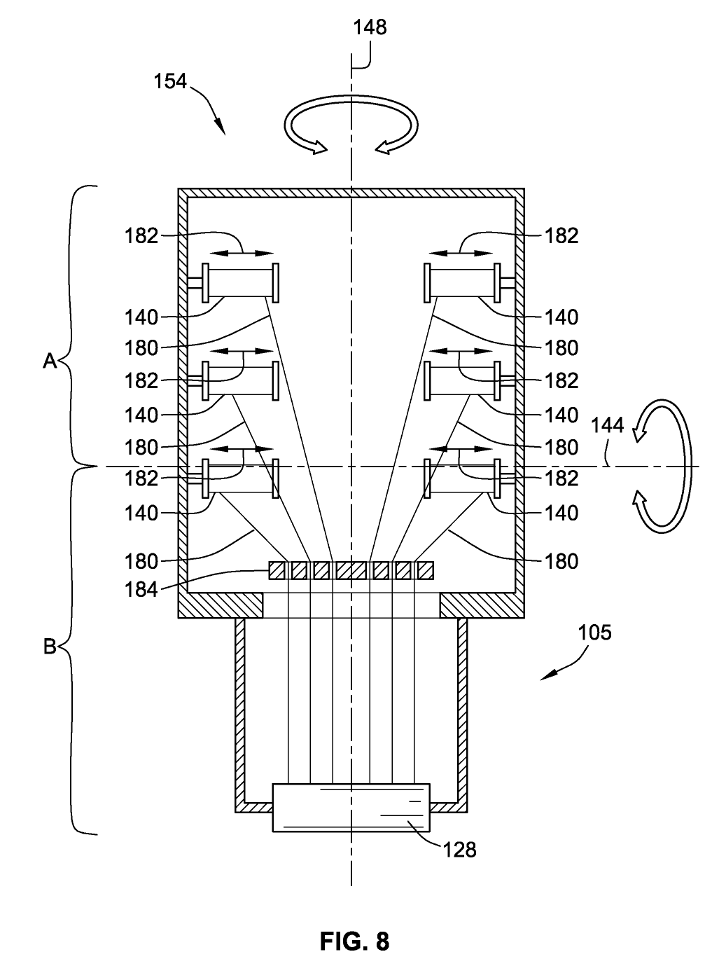

With reference to FIG. 8, the creel assembly 104, includes at least one guide arrangement 184 for guiding the individual tows 180 as the tows 180 are dispensed from the individual fiber spools 140 within the creel 124. depending on how the tows 180 are wrapped around the spools 140, the tows 180 may move laterally back and forth, as illustrated by arrows 182. This lateral movement is considered to be within the definition of “a substantially constant tow path” or “a substantially fixed tow path.” Similarly, as the spools 140 are continually removed of fiber tows 180, the radius thereof will get smaller and smaller. This adjustment in tow path will also be within the definition of “a substantially constant tow path” of “a substantially fixed tow path.”

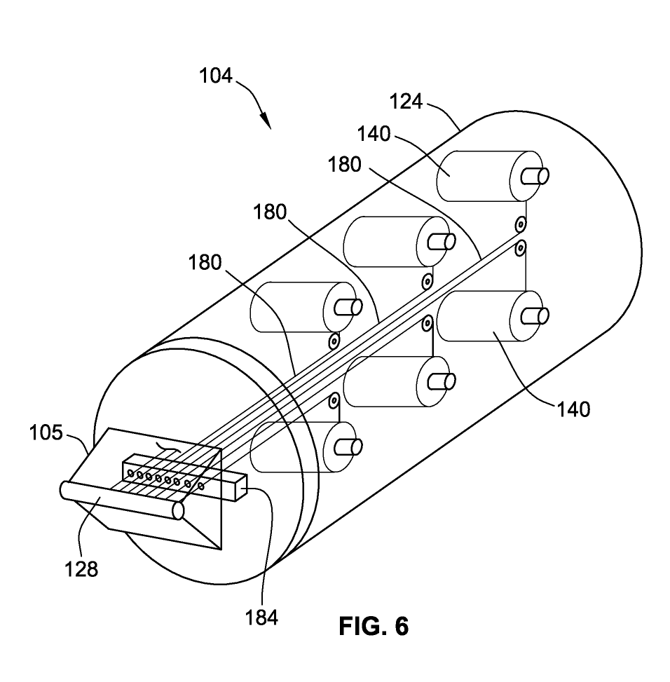

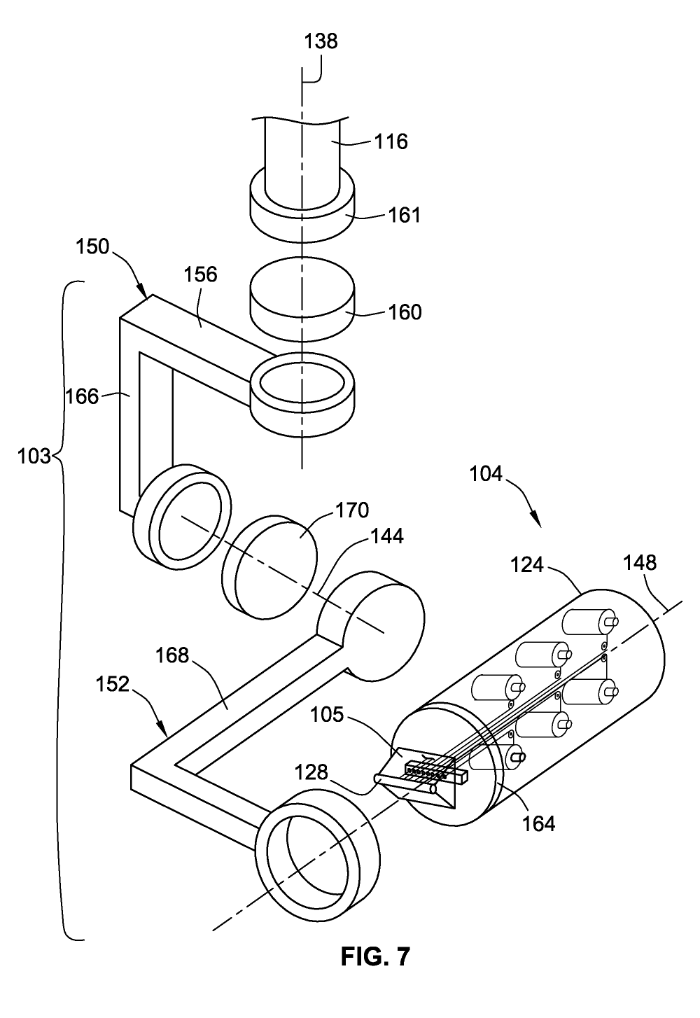

Also, individual tow paths, defined by tows 180 in FIG. 8 may pass through or over inactive devices such as substantially fixed position pulleys or guide bars to direct the tows 180 from a corresponding spool 140 to the fiber placement head 105. As illustrated in substantial schematic form in FIG. 8, a guide bar 184 is shown directing the tows along a constant straight path from the guide bar 184 to the fiber placement head 105. This guide bar 184 takes up any variation in tow path due to changes resulting from the dispensing of the tows 180 from the spools and provides a consistent path way to the fiber placement head 105. Also, the guide bars or fixed position pulleys assist in routing the tows 180 around other tows and other spools 140 (see e.g. FIGS. 6 and 7). However, because they are fixed position relative to the spools and fiber placement head 105, these guide bars and pulleys are not considered a fiber redirect arrangement/mechanism and the tow paths do not adjust due to any movement about the various degrees of freedom.

With reference to FIG. 2, the only degree of freedom between connection 161 and first wrist element 150 is rotation about first rotational axis 138. The only degree of freedom between the first wrist element 150 and the second wrist element 152 is rotation about second rotational axis 144. Further, the only degree of freedom between the spool support structure 154 and the second wrist element 152 is rotation about the third rotational axis 148. Similarly, the only degree of freedom between the second wrist element and the fiber placement head 105 is rotation about the third rotational axis 148.

In general, the rotational axis about which the compaction roller 128 rotates is fixed relative to the rotational axes about which fiber spools 140 rotate.

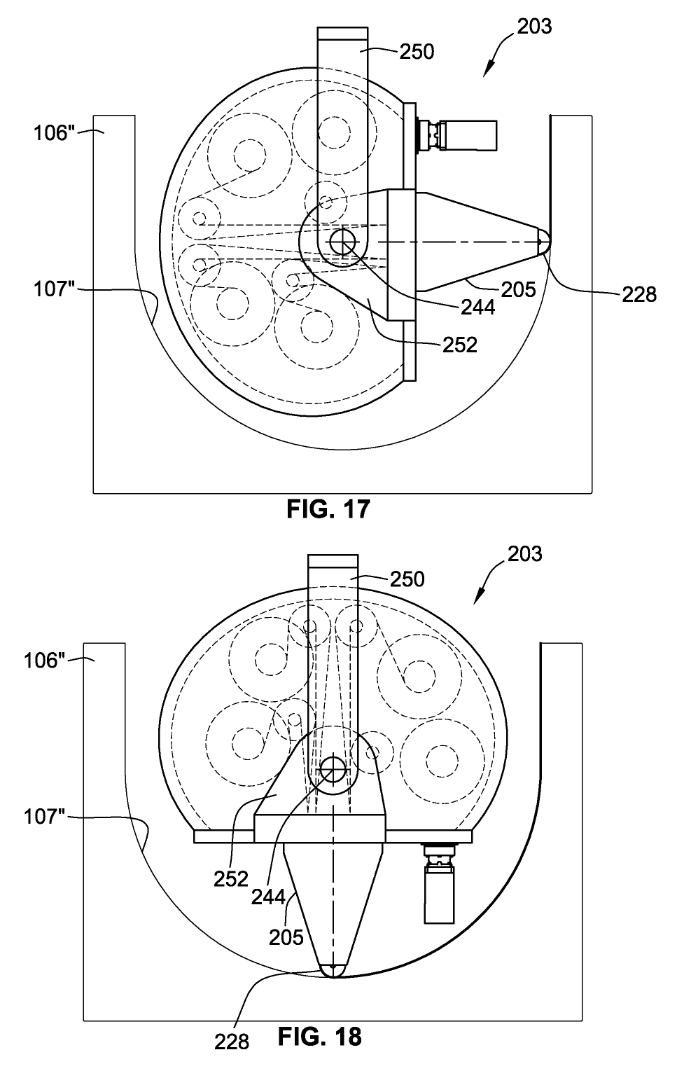

A further embodiment of a fiber placement system 200 is illustrated in FIG. 9. This system 200 uses the same gantry system 102 of FIG. 1. Attached to the vertical ram 116, is an alternative embodiment of a fiber delivery apparatus 203, having a fiber placement head 205 and compaction roller 228 for fiber tow lay-up. In this embodiment, the fiber delivery apparatus 203 bears two articulating wrists 242. The compaction roller 228 in this embodiment is smaller than the previous embodiment as fewer tows are dispensed using this embodiment as it is designed for placement of tows in a smaller envelope. Particularly, this illustration displays the variant fiber delivery apparatus 203 in relation to the fiber tow lay-up process against the inner surface of a stationary female tool 206 (similar to tool 106′ of FIG. 4 or tool 106″ of FIGS. 17 and 18), i.e. a tool that defines a cavity.

The size of the fiber delivery apparatus 203 may be reduced (and the amount of composite fiber tow spools 240 accordingly) as shown in FIG. 10. This smaller configuration is useful in providing an opportunity to utilize automated composite fiber tow manufacturing means in female or cavity tools having inverse multiple radii or acute openings of limited space, such as illustrated in FIG. 9. Preferably, all of the spools are on an opposite side of rotational axis 244 as the compaction roller 228 and more preferably a majority if not all of the fiber placement head 205 is on the opposite side.

As further illustrated in FIG. 10, this embodiment can incorporate a same mechanical interface 161 for connecting to the positioning device (i.e. gantry system 102) and particularly to ram 116. Again, this embodiment provides for three rotational degrees of freedom for rotation about axes 238, 244, 248. Servo-motors or means of movement can be used to drive the placement of the compaction roller 228 relative to the tool as discussed previously. Unlike the previous embodiment, the fiber delivery apparatus 203 includes two articulating wrist apparatus 242. The articulating wrist apparatuses 242 allow the fiber delivery apparatus 204 to be pivoted about second rotational axis 244 that extends generally perpendicular to third rotational axis 244 used to rotate the spools 240 and fiber placement head 205 relative to a mounting yoke 250. Yoke 250 is a first wrist element. Yoke 250 couples to brackets 252 which form second wrist elements via wrist articulating torque motors 270.

Again, it the articulating wrist apparatuses 242 are located axially between the compaction roller 228 and at least one of the fiber spools 240 so as to provide a more central pivot point when traveling along third rotational axis 248. Again, this facilitates a reduced footprint for use in smaller female tools.

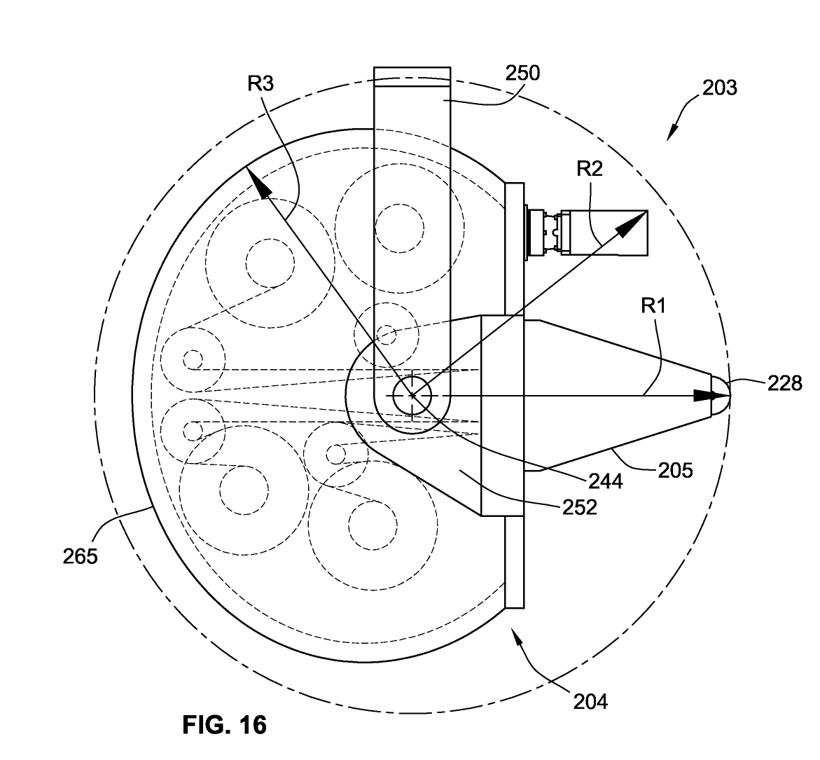

FIGS. 16-18 more clearly illustrate the small footprint provided by this design. As shown in FIG. 16, the radial distance R1 from second rotational axis 244 to the outer surface of the compaction roller 228 is the maximum distance of any component of the fiber delivery apparatus 203 rotatable about second rotational axis 244 relative to first wrist element 250 from second rotational axis 244. Additional radial distances R2 and R3 such as to outer surfaces of the creel housing 265 and to a radial maximum point of a layup inspection device are less than R1 illustrating. In other words, radius R1 defines an imaginary circular boundary centered about second rotational axis 244 in which all components remain as a result of articulation between the first and second wrist elements 250, 252 about axis 244.

FIGS. 17 and 18 illustrate the fiber delivery apparatus 203 within a female tool 106″. The radius of the inner surface 107″ of the female tool 106″ is substantially equal to R1. As such, if the second rotational axis 244 of the fiber delivery device 203 is substantially aligned with the center point of surface 107″, the fiber placement head 205 and compaction roller 228 will be permitted to rotate about axis 244 without any of the other components of the fiber delivery apparatus 203 bumping into or otherwise contacting the tool 106″.

In other words, all of the components of the fiber delivery apparatus 203 do not extend outward beyond an imaginary circular periphery having a radius R1 defined by the distance from second rotational axis 244 to the outer surface of the compaction roller 228.

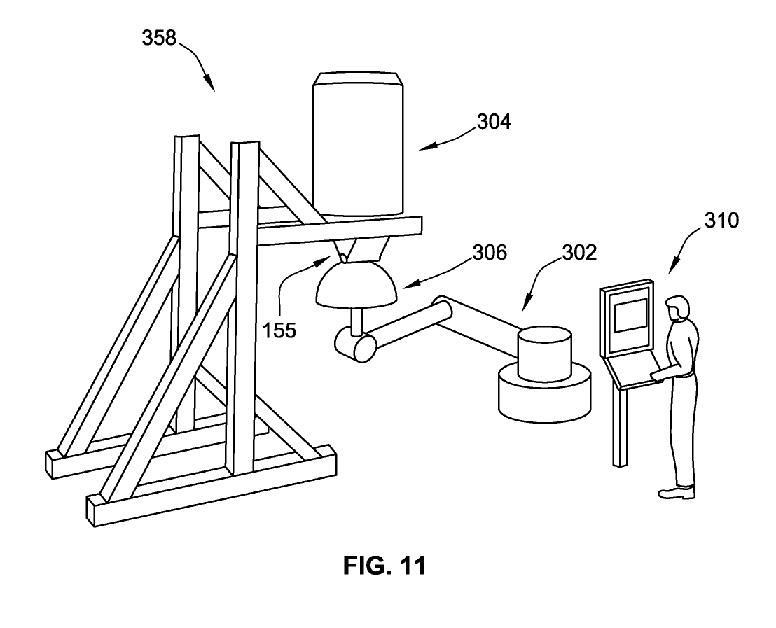

As shown in FIG. 11, another form of the preferred embodiment presents the self-contained creel assembly 304 detachably secured to a stationary storage bracket 358 while in relationship to a tool 306 detachably secured to an articulating positioner apparatus 302 in the form of a SCARA robot. Activities of the fixed position, interchangeable, detachably secured self-contained creel assembly 304 and the positioner apparatus 302 are monitored through the operator computer front end 310 simultaneously to the movements of the positioner apparatus 302 in relation to the self-contained creel assembly 304.

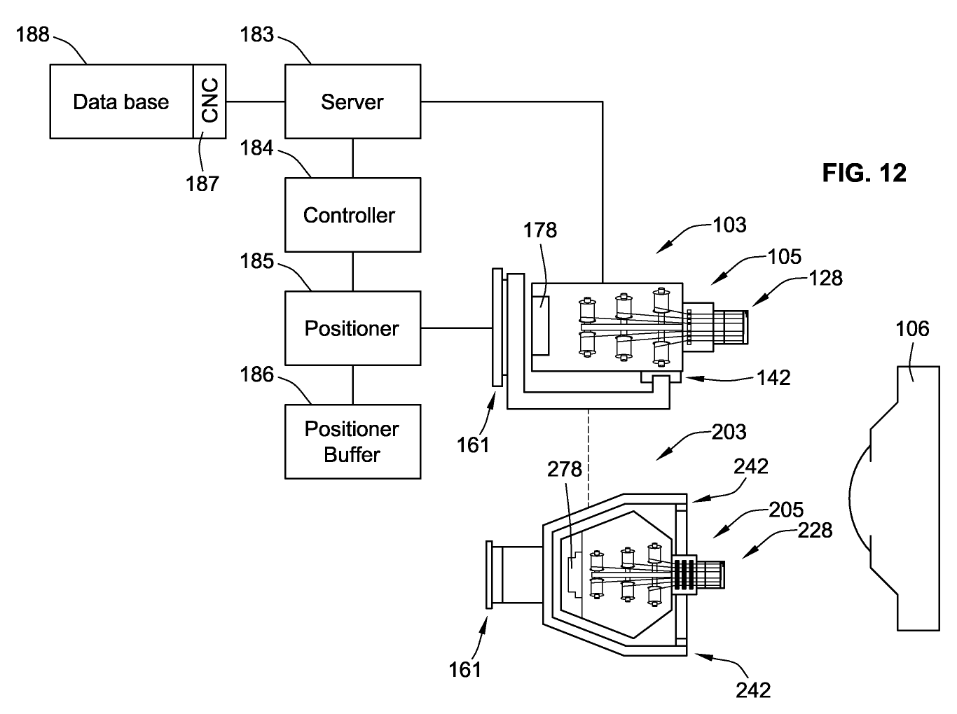

FIG. 12 illustrates additional features of embodiments of the present invention. Within the creel assembly 104 is an internal autonomous controller 178 having a programmable logic controller), having a real time processor contained therein. The internal autonomous controller 178 receives an input signal from the server 183. Simultaneously the positioner controller 184 also receives a signal from server 183 and then relays that input signal to the positioner 185 (i.e. gantry system 102). Positioner 185 begins the transfer of executable demands to the controller/positioner buffer 186. The positioner buffer 186 is a means of accumulating data sequentially to facilitate a faster rate of tow application. The positioner buffer 186 receives and holds a predetermined amount of data from the controller 184 and as the lay-up process is executed, the executed commands of the CNC master design 187 are transferred from the database 188 through the server 183 to the controller 184 and replaced in the positioner buffer 186. While the positioner 185 transfers the executable demands to the controller/positioner buffer 186, the internal autonomous controller 178 receives the tow events executable demands.

The positioner 185 executes the movement of the self-contained creel assembly 104 and/or the tool, mold or rotating mandrel 106. The executable demands, as stored in the positioner buffer 186 are delivered to the creel assembly 104 in concert with the movements of the positioner 185. As these executable demands are delivered, the internal autonomous controller 178 simultaneously executes some or all fiber placement head 105 events upon the tows being delivered to the compaction roller 128. Further, the internal autonomous controller can control some or all of the servo torque motors for driving about the three rotational axes 138, 144, 148. The internal autonomous controller 178 having the real time programmable logic controller may then execute the events and control the position of the compaction roller 128 and fiber placement head 105 as programmed by the CNC master design 187 in segments of milliseconds, exponentially faster than the present state of the art systems or devices.

Further, the internal autonomous controller 178 executes the fiber placement head 105 events based on a known position along a given layup/lay down path as informed by the positioner 185. More particularly, fiber placement head 105 receives at least one axis position, typically referred to as the u-axis position, of the positioner 185 or alternatively a position of the fiber placement head 105 from the positioner 185. Because the internal autonomous controller 178 is loaded with the CNC master design 187 and knows which particular layup/lay down pathway it is working on, the internal autonomous controller 178 can determine when to execute the fiber placement head 105 events. Further, the internal autonomous controller 178 can determine or be provided by the positioner 185 movement characteristics of the self-contained creel assembly 104 such as its speed along a give tow layup/lay down pathway such that proper timing of initiation of the fiber placement head 105 events can occur.

It is a significant advantage of the present embodiment that the internal autonomous controller 178, i.e. the controller that initiates some of if not all of the fiber placement head events, is located on the self-contained creel assembly 104. This arrangement reduces a significant latency effect from the prior art that occurred when the control commands relating to the fiber placement head 105 events were dispatched from a controller located at the front end station 110. Due to required accuracy and avoidance of tow fouling, latency effects of mere fractions of a millisecond can generate problems or undesirable accuracy within the system.

A further benefit of locating a controller that controls the fiber placement head 105 events on the actual self-contained creel assembly 104 rather than at the front end station 110 is that each individual internal autonomous controller 178 can be tailored to the corresponding self-contained creel assembly 104 and particularly the fiber placement head 105 thereof. This prevents the need to have software that is compatible with various different operator front end stations 110.

A further benefit of the present embodiment is that the control demands for at least the control of the positioner 185 and the fiber placement head 105 events are bifurcated such that they are not being performed by a single controller. Thus, this significantly reduces the individual processing size required for a single controller that would be required to perform both tasks.

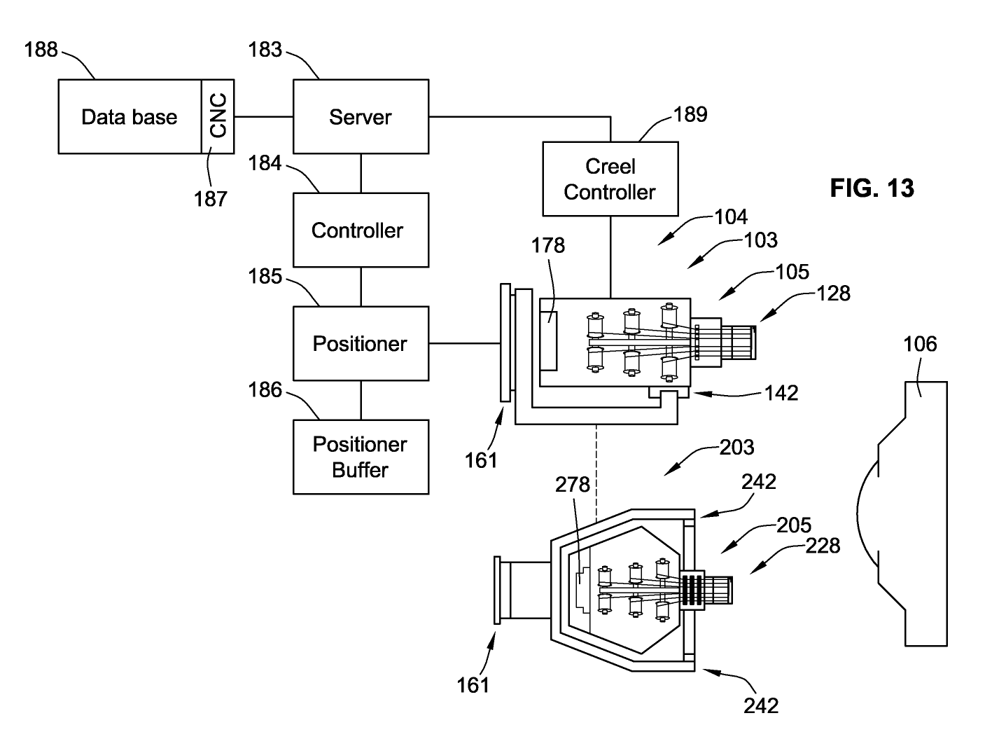

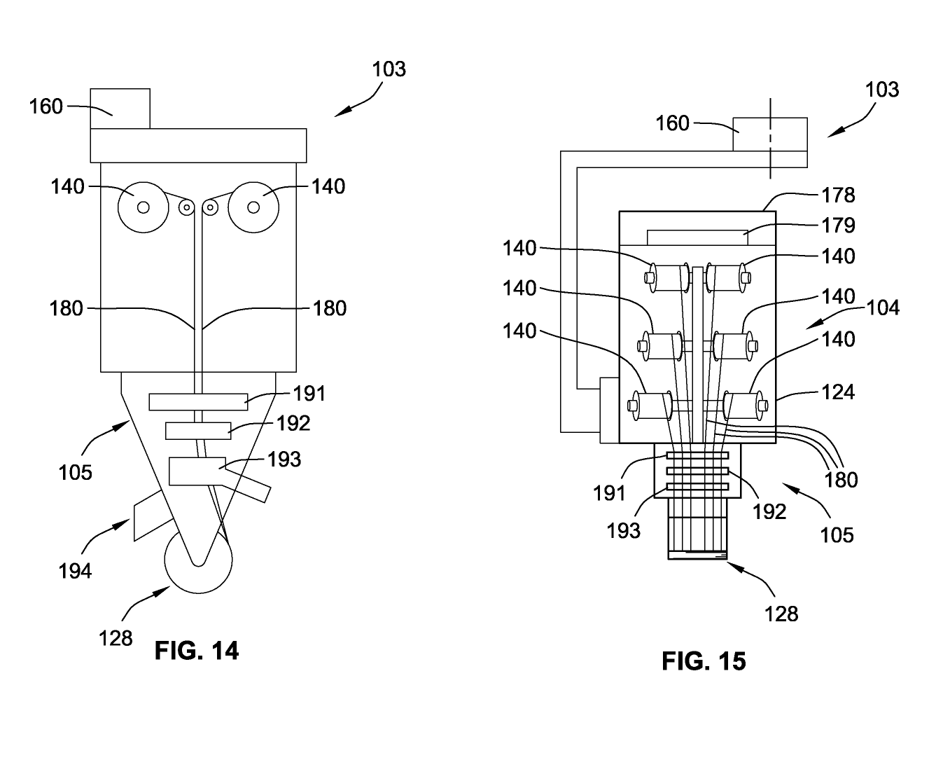

FIG. 13 is a schematic representation of a further embodiment. In this embodiment, a third controller, a creel controller 189 is provided. In this embodiment, the creel controller 189 controls, at least, the dispensing of tows from fiber spools 140. More particularly, the fiber spools 140 are driven by servo motors 190 or other motors or means for rotation under direction of controller 189. The creel controller 189 is in communication with server 183 and database 188 such that it receives the CNC master design much like controllers 184 and 178. The creel controller 189 then uses the CNC master design to determine the rate at which tows 180 need to be dispensed from the spools 140 to maintain the proper tension in the tows 180 as they are being used by the fiber placement head 105.

Again, the creel controller 189 like the internal autonomous controller 178 described previously can obtain positioning information from the positioner 185 to then calculate or determine how tow is to be dispensed from the fiber spools 140. Also, the creel controller 189 typically bases its calculations on the knowledge of which tow layup/lay down pathway it is working on and a single axis data point, typically the u-axis value. Again, by analyzing the information from the positioner 185 in concert with the CNC master design, the creel controller 189 can determine where and at what rate the fiber placement head 105 is placing tow and know how much tow 180 at which tension needs to be dispensed from each of the individual fiber spools 140.

While illustrated schematically in FIG. 13 as being external to the self-contained creel assembly 104, the creel controller 189 may be mounted within the self-contained creel assembly 104. Further, the creel controller 189 could be located at the front end station 110. Also, the creel controller 189 and the internal autonomous controller 178 may be formed into a single module. Further yet, the internal autonomous controller 178 could be configured to control the individual fiber spools 140 without the use of a separate creel controller.

The self-contained creel assembly 104 includes the internal autonomous controller 178 having within its configuration a programmable logic controller equipped with specific hardware and software in machine readable format that are configured to communicate and interact with the database 188 having the CNC master design 187 that is executed through a server 183, as shown in FIGS. 12 and 13.

Additionally, the self-contained creel assembly 104 has at least two composite fiber spools 140 mounted internally and accessible from the outside of the creel assembly 104, mounted in a configuration parallel to the linear axis of the compaction roller 128. Thus, the compaction roller 128 and fiber spools 140 rotate about parallel axes. However, in alternative embodiments they could be arranged such that they are not rotating about parallel axis but require a minor twist in the tow as it transfers from the spools 140 to the compaction roller 128.

However, in this example, the composite fiber spools 140 are so configured to facilitate a direct fiber tow path. The direct fiber tow path eliminates the need for any active fiber redirect means once dispensed from the fiber spools 140, such as dancer arrangements or idler pulleys. The direct tow path prevents the significant redirection of the tows such that they are caused to undesirably bend which can result in the undesirable fraying or degradation of the tows prior to placement as identified previously. Some minimal static bars or rollers, i.e. non-active redirect, may be provided to direct the flow of the tows along the path.

Passing directly from the composite spools 140 to the compaction roller 128, the fiber tows are presented to the fiber placement head 105 for utilization of a cut or add mechanism 191, a real time visual inspection system 192 and an infrared tow heater 193 prior to application and compaction as determined by the CNC master design 187 in concert with the internal autonomous controller's 178 programmable logic controller. In this embodiment, a post compaction real time visual inspection system component 194 is also controlled by the autonomous controller 178 and CNC master design 187. Such immediate interactive communication and execution of fiber placement head 105 events enables the operations to increase in speed and efficiency.

It should be noted that because the autonomous controller 178 is mounted in the creel assembly 104, the controller is also manipulated via the degrees of freedom provided by the fiber delivery apparatus 103.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fiber delivery apparatus for the manufacture of composite fiber laminated products comprising;
an articulating wrist apparatus including first and second wrist elements operably coupled to one another for pivotable movement therebetween about a wrist articulation axis;
a creel assembly storing a plurality of fiber spools therein, the creel assembly mounted to the second wrist element for rotation about the wrist articulation axis relative to the first wrist element;
a fiber placement head mounted to the second wrist element, the fiber spools and fiber placement head being simultaneously rotatable relative to the second wrist element about a head rotation axis being perpendicular to the wrist articulation axis, the fiber placement head being maintained in a substantially fixed position relative to the fiber spools; and
a compaction roller attached to the fiber placement head.

2. The apparatus of claim 1, further comprising a tow path between each of the plurality fiber spools and, at least, the fiber placement head, the tow paths being free of an active redirect mechanism between the fiber spools and the fiber placement head such that the tow paths maintain a substantially constant length.

3. The apparatus of claim 1, further comprising a tow path between each of the plurality fiber spools and, at least, the fiber placement head, the tow paths being free of an active redirect mechanism between the fiber spools and the fiber placement head such that the tow paths maintain substantially constant.

4. The apparatus of claim 1, further comprising a connection arrangement for releasably coupling the fiber delivery apparatus to a positioner such that the fiber delivery apparatus is a complete module, the connection arrangement being rotatable relative to the first wrist element about a wrist rotation axis, the wrist rotation axis being perpendicular to the wrist articulation axis.

5. The apparatus of claim 1, wherein the creel assembly further includes a housing and spool support structure within the housing, the spool support structure supporting the spools, the spool support structure being rotatable relative to the second wrist element about the head rotation axis in unison with the fiber placement head.

6. The apparatus of claim 5, wherein the housing is fixed relative to the second wrist element and the spool support structure rotates within the housing.

7. The apparatus of claim 1, wherein the creel assembly further includes a spool support supporting the fiber spools, the spool support structure being rotatable relative to the second wrist element about the head rotation axis in unison with the fiber placement head, wherein at least a portion of the spool support structure is positioned on a first side of the wrist articulating axis and the compaction roller is on an opposite second side of the wrist articulating axis.

8. The apparatus of claim 1, wherein the compaction roller is axially spaced from at least one of the fiber spools along the head rotation axis, and wherein the wrist articulating axis is axially interposed along the head rotation axis between the at least one of the fiber spools and the compaction roller.

9. The apparatus of claim 4, wherein the wrist rotation axis provides the only degree of freedom between the connection arrangement and the first wrist element, the wrist articulation axis provides the only degree of freedom between the first wrist element and the second wrist element, the head rotation axis provides the only degree of freedom between the second wrist element and the fiber placement head, the head rotation axis provides the only degree of freedom between the second wrist element and an axis about which each fiber spool rotates.

10. The apparatus of claim 1, wherein all components of the fiber delivery apparatus rotatable about the wrist articulation axis relative to the first wrist element lie within an imaginary boundary defined by a circle centered about the wrist articulation axis having a radius defined between the wrist articulation axis and the compaction roller.

11. The apparatus of claim 1, further comprising a tow path between each of the plurality fiber spools and, at least, the fiber placement head, wherein the entire portion of the tow paths extending between the fiber spools and the fiber placement head is entirely internal to the fiber delivery apparatus.

12. The apparatus of claim 1, further comprising a tow path between each of the plurality fiber spools and, at least, the fiber placement head, substantially the only degree of freedom between the portion of the tow paths between each of the plurality fiber spools and, at least, the fiber placement head is rotation about the head rotation axis.

13. The apparatus of claim 1, further comprising a tow path between each of the plurality fiber spools and, at least, the fiber placement head, the tow paths being free of an active redirect mechanism between the fiber spools and the fiber placement head such that the tow paths maintain a substantially constant length and configuration;
further comprising a connection arrangement for releasably coupling the fiber delivery apparatus to a positioner such that the fiber delivery apparatus is a complete module, the connection arrangement being rotatable relative to the first wrist element about a wrist rotation axis, the wrist rotation axis being perpendicular to the wrist articulation axis;
wherein the creel assembly further includes a housing and spool support structure within the housing, the spool support structure supporting the spools, the spool support structure being rotatable relative to the second wrist element about the head rotation axis in unison with the fiber placement head, the housing being fixed relative to the second wrist element and the spool support structure rotates within the housing;
wherein at least a portion of the spool support structure is positioned on a first side of the wrist articulating axis and the compaction roller is on an opposite second side of the wrist articulating axis along the head rotation axis; and
wherein the wrist rotation axis provides the only degree of freedom between the connection arrangement and the first wrist element, the wrist articulation axis provides the only degree of freedom between the first wrist element and the second wrist element, the head rotation axis provides the only degree of freedom between the second wrist element and the fiber placement head, the head rotation axis provides the only degree of freedom between the second wrist element and an axis about which each fiber spool rotates.

14. The apparatus of claim 9, wherein all components of the fiber delivery apparatus rotatable about the wrist articulation axis relative to the first wrist element lie within an imaginary boundary defined by a circle centered about the wrist articulation axis having a radius defined between the wrist articulation axis and the compaction roller.

15. A fiber delivery apparatus for the manufacture of composite fiber laminated products comprising;
an articulating wrist apparatus including first and second wrist elements operably coupled to one another for pivotable movement therebetween about a wrist articulation axis;
a creel assembly storing a plurality of fiber spools therein, the creel assembly mounted to the second wrist element for rotation about the wrist articulation axis relative to the first wrist element;
a fiber placement head mounted to the second wrist element, the fiber placement head being maintained in a substantially fixed position relative to the fiber spools;
a compaction roller attached to the fiber placement head, the compaction roller always being axially spaced from at least one of the fiber spools along an offset axis that is generally perpendicular to both the wrist articulation axis and an axis of rotation of the compaction roller and the wrist articulating axis is axially interposed along the offset axis between the at least one of the fiber spools and the compaction roller.

16. The fiber delivery apparatus of claim 15, wherein all components of the fiber delivery apparatus rotatable about the wrist articulation axis relative to the first wrist element lie within an imaginary boundary defined by a circle centered about the wrist articulation axis having a radius defined between the wrist articulation axis and the compaction roller.

17. The fiber delivery apparatus of claim 16, wherein the tow path between the plurality of fiber spools and the fiber placement head is fixed in length and orientation and free of a fiber redirect mechanism for transitioning the tow path between differently shaped paths.

18. A fiber delivery apparatus for the manufacture of composite fiber laminated products comprising;
a plurality of fiber spools therein; and
a fiber placement head in a fixed relationship to the fiber placement spools such that tow paths between the fiber spools and the fiber placement head are substantially fixed in length and substantially fixed in orientation.

19. The fiber delivery apparatus of claim 18, being free of any fiber redirect mechanism along the tow paths between the fiber spools and the fiber placement head.

20. The fiber delivery apparatus of claim 19, further including at least one static guide device along each tow path altering a direction in the tow path, the alteration in direction being a fixed alteration.
